(19) United States
(12) Patent Application Publication
(10) Pub. No.: US 2009/0208275 A1
(43) Pub. Date: Aug. 20, 2009

(54) STRUCTURE FOR EXHAUST PIPE CONNECTION SECTION OF MUFFLER

(75) Inventor: Takenori Saito, Saitama (JP)

Correspondence Address: FOLEY AND LARDNER LLP;SUITE 500, 3000 K STREET NW, WASHINGTON, DC, 20007, US

(73) Assignee: CALSONIC KANSEI CORPORATION

(21) Appl. No.: 12/375,056

(22) PCT Filed: Jun. 26, 2007
(86) PCT No.: PCT/JP2007/062765

§ 371 Date: Jan. 26, 2009

(30) Foreign Application Priority Data
Jul. 27, 2006 (JP) 2006-204487

(51) Int. Cl. F16L 13/04

(52) U.S. Cl. 403/271

(57) ABSTRACT

In an exhaust pipe connecting structure of a muffler, a through-hole 11a that penetrates one side wall portion of an outer shell 11 has a diameter larger than an outer diameter of an inlet pipe 2. The inlet pipe 2 is fixed at its portion corresponding to the through-hole 11a with a reinforcement-spacer member 3 having a cylindrical portion 31 that is gas-tightly connected with an outer circumferential surface of a projecting portion of the inlet pipe 2 and a flange portion 32 that projects outwardly from a through-hole side edge portion of the cylindrical portion 31. The flange portion 32 of the reinforcement-spacer member 3 is fixed by welding on an outer surface of the outer shell 11 all around the through-hole 11a. The cylindrical portion 31 of the reinforcement-spacer member 3 is fixed by welding on an outer circumferential surface of the inlet pipe 2 all around thereof. A stay 4 is provided with an insertion hole 41 coaxial with the cylindrical portion 31 of the reinforcement-spacer member 3 in a hollow part of the muffler main body, flange portions 43 at both end portion of a basal plate portion 42 of the stay 4 is fixed by welding on an inner surface of the outer shell 11. An end portion of the inlet pipe 2 is supported in a state where the end portion thereof is inserted in the insertion hole 41 of the stay 4.

### TECHNICAL FIELD

The present invention relates to an exhaust pipe connecting structure of a muffler that constitutes a part of an exhaust system connected with an engine of a motor vehicle.

### BACKGROUND OF THE INVENTION

A conventional exhaust pipe connecting structure of a muffler is disclosed in Japanese Patent Application Laid-Open No. 2005-330839. In this conventional exhaust pipe collecting structure, a muffler main body has an outer shell with side wall portions, which are provided with through-holes that penetrate the side wall portions, respectively, so that a hollow part thereof can be communicated with an exterior thereof through the through-holes. An exhaust pipe with one end portion that is blocked off is inserted into the through-holes, and its side wall portion is formed with a plurality of communicating holes for communicating an inner space of the exhaust pipe with the hollow part of the muffler main body. The diameters of the through-holes are formed larger than an outer diameter of the exhaust pipe. On a portion of the exhaust pipe corresponding to the thorough-hole, a pair of reinforcement-spacer members are fixed, respectively, where the reinforcement-spacer members have a cylindrical portion gas-tightly contacted with an outer circumferential surface of the exhaust pipe and a flange portion projecting outwardly from a through-hole side edge portion of the cylindrical portion. The flange portion of the reinforcement-spacer member is fixed with an outer surface of the outer shell by welding all around the through-hole, and the cylindrical portion thereof is fixed by an outer surface of the exhaust pipe by welding all around the exhaust pipe.

### DISCLOSURE OF THE INVENTION

### Problem(s) To Be Solved By The Invention

The above-described conventional invention can ensure the connecting strength of an exhaust pipe connecting structure and side wall portion of the muffler main body, because the exhaust pipe penetrates the hollow part of the muffler main body and the exhaust pipe is supported by the pair of reinforcement-spacer members.

On the other hand, in a case where a muffler is constructed in such a way that an exhaust pipe opens in a hollow part of a muffler main body or it is connected with an inner pipe arranged in an hollow part of the muffler main body in a state where the exhaust pipe penetrates a side wall portion of the muffler main body to obtain a simple and inexpensive structure compared to the above conventional two-point support structure, there is a problem in that the connecting strength between a reinforcement-spacer member and the side wall portion of the muffler main body is not sufficient because the exhaust pipe is one-point supported.

The problem to be solved by the resent invention is to provide an exhaust pipe connecting structure of a muffler that can increase the connecting strength of welded portions of a reinforcement-spacer member and a side wall portion of a muffler main body in a structure where an exhaust pipe opens in a hollow part of the muffler main body or the exhaust pipe is connected with an inner pipe arranged in the hollow part in a state where the exhaust pipe penetrates the side wall portion of the muffler main body.

### Means For Solving The Problems

According to a first aspect of the present invention there is provided an exhaust pipe connecting structure of a muffler in which a through-hole is provided in one side wall portion of an outer shell of a muffler main body to penetrate a side wall portion in a state where an exhaust pipe is inserted into and supported by the through-hole. A diameter of the through-hole is formed larger than an outer diameter of the exhaust pipe. The exhaust pipe is fixed at a portion thereof corresponding to the through-hole with a reinforcement-spacer member that has a cylindrical portion and a flange portion, the cylindrical portion being gas-tightly connected with an outer circumferential surface of a projecting portion of the exhaust pipe and the flange portion being projected outwardly from a through-hole side edge portion of the cylindrical portion. The flange portion of the reinforcement-spacer member is fixed by welding on an outer surface of the outer shell all around the through-hole and the cylindrical portion of the reinforcement-spacer member is fixed by welding on the outer circumferential surface of the exhaust pipe all around the exhaust pipe. An stay is provided with an insertion hole that is arranged in co-axial with the cylindrical portion of the reinforcement-spacer member in a hollow part of the muffler main body, the stay having flange portions formed at both end thereof being fixed by welding on an inner surface of the outer shell. An end portion of the exhaust pipe is supported by the stay in a state where the end portion is inserted in the insertion hole of the stay.

### EFFECT OF THE INVENTION

In the exhaust pipe connecting structure of the muffler of the present invention, the stay is provided with the insertion hole that is arranged in co-axial with the cylindrical portion of the reinforcement-spacer member in the hollow part of the muffler main body, the stay having flange portions formed at both end thereof being fixed by welding on the inner surface of the outer shell. The end portion of the exhaust pipe is supported by the stay in the state where the end portion is inserted in the insertion hole of the stay. As a result, the exhaust pipe is two-point supported by the cylindrical portion of the reinforcement-space member and the insertion hole of the stay, so that the stress generated due to a relative movement between the exhaust pipe and the outer shell. Therefore, the strength of the welding portions of the reinforcement-spacer member and the side wall portion of the muffler main body in a structure where the exhaust pipe penetrates the wall portion of the muffler main body to open into the hollow part of the muffler main body or it is connected with an inner pipe that is arranged in the hollow part thereof.

### BRIEF DESCRIPTION OF THE DRAWINGS

The objects, features and advantages of the present invention will become apparent as the description proceeds when taken in conjunction with the accompanying drawings, in which:

FIG. 1 is a plan view showing a muffler to which an exhaust pipe connecting structure of the muffler of a first embodiment according to the present invention is applied;

FIG. 2 is an enlarged cross sectional view of the muffler taken along a line A-A in FIG. 1;

FIG. 3 is a view of the muffler seen along an arrow B in FIG. 2;

FIG. 4 is a front view showing a stay that is used for the muffler of the first embodiment;

FIG. 5 is a longitudinal cross sectional view of the stay taken along a line C-C in FIG. 4;

FIG. 6 is a cross sectional view of stay taken along a line D-D in FIG. 4; and

FIG. 7 is a schematic diagram of the muffler to which the exhaust pipe connecting structure of the muffler of the first embodiment is applied.

### DESCRIPTION OF REFERENCE NUMBERS

1 muffler main body
1a first sound attenuation chamber (resonant chamber)
1b second sound attenuation chamber (expansion chamber)
1c third sound attenuation chamber (resonant chamber)
1d fourth sound attenuation chamber (expansion chamber)
1c fifth sound attenuation chamber (expansion chamber)
11 outer shell
11a through-hole
12 outer plate
13 outer plate
14 inner plate
15 inner plate
16 inner plate
17 inner plate
17a small communicating hole
2 inlet pipe (exhaust pipe)
3 reinforcement-spacer member
31 cylindrical portion
32 flange portion
4 stay
41 insertion hole
41a cylindrical portion
42 basal plate portion
42a reinforcement rib
5 first inner pipe
51 straight pipe
51a small-diameter end portion
51b small communicating hole
52 L-letter shaped pipe
6 second inner pipe
7 first outlet pipe
7a hole
8 second outlet pipe
8a small hole
9 gasket (annular sealing member)

### BEST MODE FOR CARRYING OUT THE INVENTION

Throughout the following detailed description, similar reference characters and numbers refer to similar elements in all figures of the drawings, and their descriptions are omitted for eliminating duplication.

Hereinafter, an embodiment of the present invention will be described with reference to the accompanying drawings.

### First Embodiment

First an exhaust pipe connecting structure of a muffler of a first embodiment will be described.

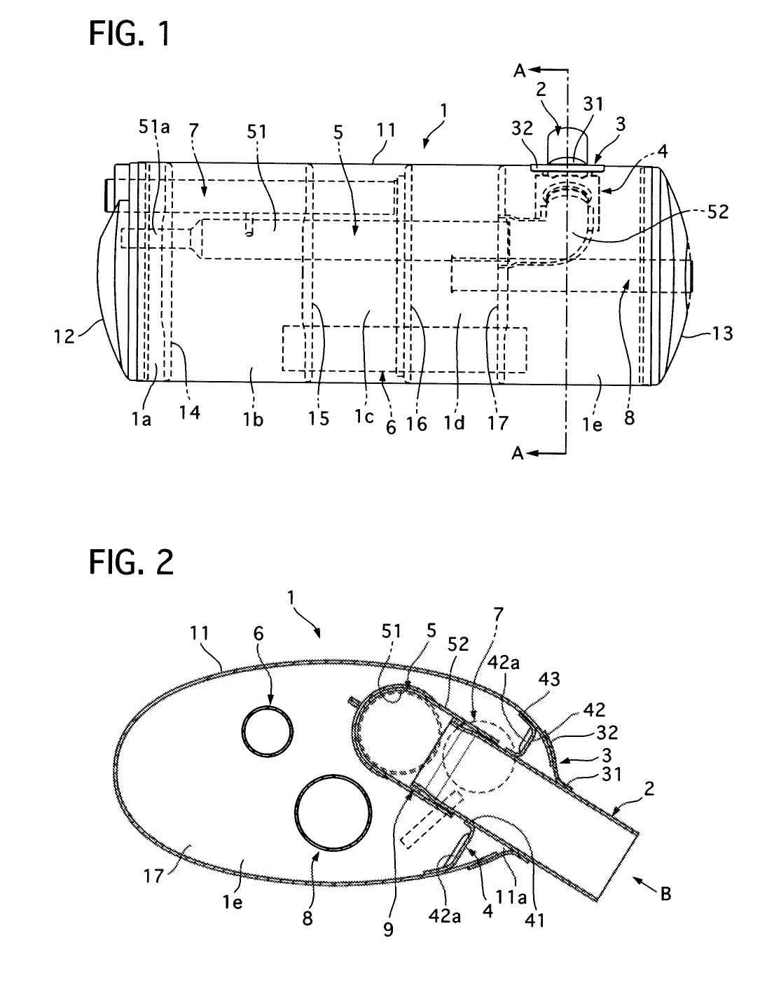

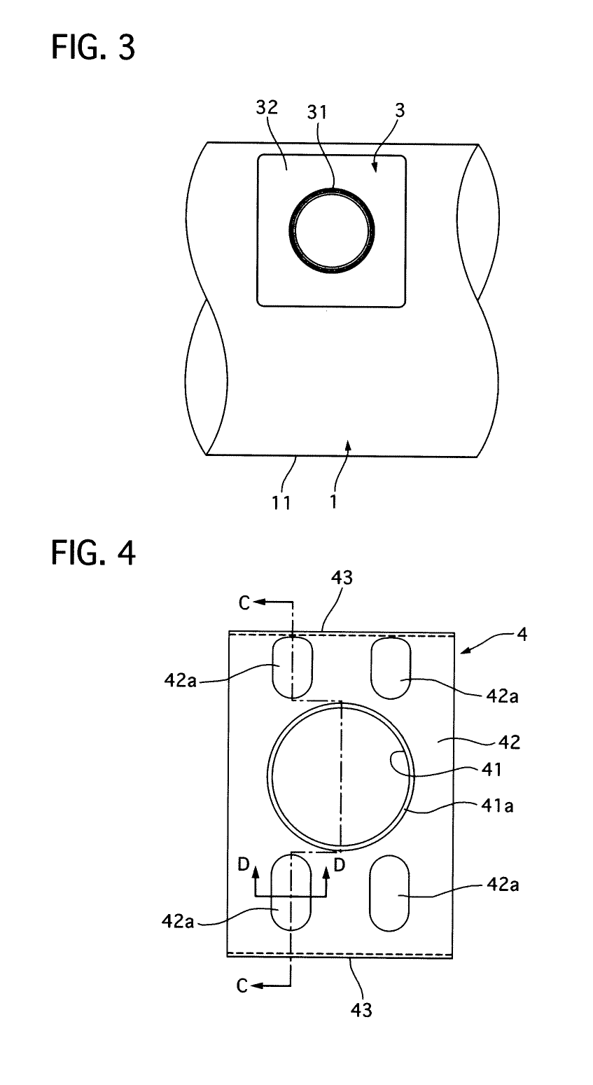

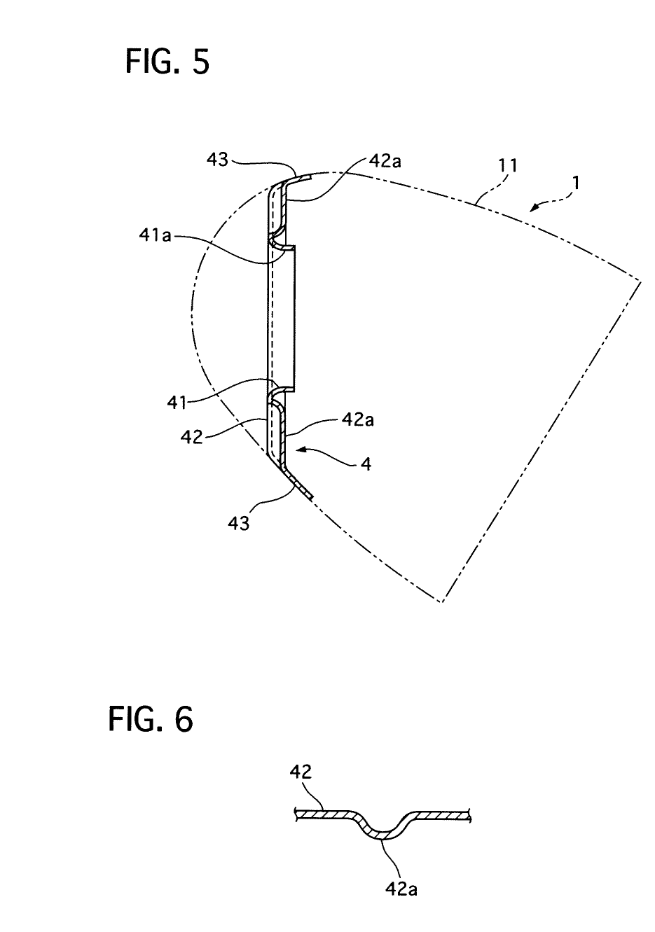

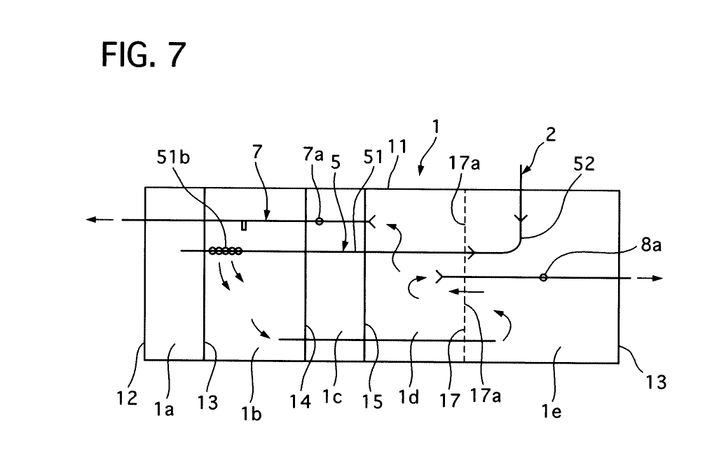

FIG. 1 is a plan view showing the muffler to which the exhaust pipe connecting structure of the muffler of the first embodiment is applied, FIG. 2 is an enlarged cross sectional view of the muffler taken along a line A-A in FIG. 1, FIG. 3 is a view showing the muffler seen along an arrow B, FIG. 4 is a front view of a stay, FIG. 5 is a longitudinal cross sectional view of the sty taken along a line C-C in FIG. 4, FIG. 6 is a cross sectional view of the stay taken along a line D-D in FIG. 4, and FIG. 7 is a schematic diagram of the muffler to which the exhaust pipe connecting structure of the muffler of the first embodiment is applied.

The muffler of the first embodiment includes a muffler main body 1, an inlet pipe (corresponding to an exhaust pipe ) 2, a reinforcement-spacer member 3, a stay 4, a first inner pipe 5, a second inner pipe 6, a first outlet pipe 7 and a second outlet pipe 8.

Specifically, as shown in FIG. 1 and FIG. 7, the muffler main body 1 has an outer shell that is formed like an oval cylinder shape, a pair of outer plates 11 and 12 for blocking off both of opening portions of the outer shell 11, and four inner plates 14 to 17 for divides an inner space of the outer shell 11.

The muffler main body 1 is provided, by using the inner plates 14 to 17, in a longitudinal direction thereof at predetermined intervals with five chambers: a first sound attenuation chamber (corresponding to a resonant chamber) 1a, a second sound attenuation chamber (corresponding to an expansion chamber) 1b, a third sound attenuation chamber (corresponding to a resonant chamber) 1c, a fourth sound attenuation chamber (corresponding to an expansion chamber) 1d and a fifth sound attenuation chamber (corresponding to an expansion chamber) 1e. Incidentally, the inner plate 17 is formed with a lot of small communicating holes 17a.

As shown in FIG. 2 and FIG. 3, the inlet pipe 2 penetrates one side wall portion of the outer shell 11. That is, in the side wall portion of the outer shell 11, a thought-hole 11a, which has a diameter larger than an outer diameter of the inner pipe 2, is provided in a state where it communicates with the sound attenuation chamber 1e, and the inlet pipe 2 is inserted through the through-hole 11a.

The reinforcement-spacer member 3 functions to block off a gap generated between the inner pipe 2 and the through-hole 11a formed in the side wall portion of the outer shell 11 and to connect and fix the outer shell 11 and the inlet pipe 2 with each other. The reinforcement-spacer member 3 includes a cylindrical portion 31 and a flange portion 32, where the cylindrical portion 31 gas-tightly contacts with an outer circumferential surface of the inlet pipe 2 corresponding to an outer side of the outer shell 11, and the flange portion 32 has a cross section shaped like a circular arc formed along an outer surface of the outer shell 11.

The flange portion 32 of the reinforcement-spacer member 3 is fixed by welding on the outer surface of the outer shell 11 all around the through-hole 11a, and the cylindrical portion 31 of the reinforcement-spacer member 3 is fixed by welding on the outer circumferential surface of the inlet pipe 2 all around the inlet pipe 2. Incidentally, the welding may employ all kinds of welding such as plasma welding, laser welding, seam welding and TIG welding.

The stay 4 respectively has, as shown in FIG. 2 and FIGS. 4 to 6, flange portions 43 at both end portions of the basal plate portion 42, which is provided with an insertion hole 41 that is arranged in co-axial with the cylindrical portion 31 of the reinforcement-spacer member 3 in the hollow part of the muffler main body 1, and the flange portion 43 is fixed by welding on the inner surface of the outer shell 11.

The insertion hole 41 of the stay 4 is formed to have a diameter sufficient enough to be penetrated by the inlet pipe 2, and around and along the insertion hole 41, a cylindrical portion 41a is provided on the stay 4 so that the cylindrical portion 41a projects toward the hollow part of the muffler main body 1. In addition, the basal plate portion 42 is formed with four reinforcement ribs 42a.

One end side portion of the inlet pipe 2 is inserted into and supported by the insertion hole 41 and the cylindrical portion 41a of the stay 4.

As shown in FIG. 1 and FIG. 7, the first inner pipe 5 penetrates all the inner plates 14 to 17, and a small-diameter end portion thereof consists of a straight pipe 51 and an L-letter shaped pipe 52, where the straight pipe 51 opens into the first sound attenuation chamber (the resonant chamber) 1a, and one end portion of the L-letter shaped pipe 52 is connected with the other end portion of the straight pipe 51 with an opening that opens into an inner space of the fifth sound attenuation chamber 1e. An end portion of the inlet pipe 2 is inserted into an opening of the other end portion of the L-letter shaped pipe 52 through a gasket, namely an annular sealing member, 9.

A wall portion of the straight pipe 51 is formed with a lot of small communicating holes 51b that communicates with an inner space of the second sound attenuation chamber (the expansion chamber) 1b.

The second inner pipe 6 penetrates the inner plates 15 to 17 in a state where it communicates the second attenuation chamber (the expansion chamber) 1b and the fifth sound attenuation chamber (the expansion chamber) 1e with each other.

The first outlet pipe 7 penetrates the outer plate 12 and the inner plates 14 to 16, so that an inlet port side thereof opens into the fourth sound attenuation chamber (the expansion chamber) Id and an outlet port side thereof is arranged at the exterior of the muffler main body 1. The side wall portion of the first outlet pipe 7 is formed with a hole 7a that communicates with the third sound attenuation chamber (the resonant chamber) 1c.

The second outlet pipe 8 penetrates the inner plate 17 and the outer plate 13, so that an inlet port side thereof opens into the fourth sound attenuation chamber (the expansion chamber) 1d and an outlet port side thereof is arranged at the exterior of the muffler main body 1. The wall portion of the second outlet pipe 8 is formed with a small hole 8a that communicates with the fifth attenuation chamber (the expansion chamber) 1e.

Next, the operation of the exhaust pipe connecting structure of the muffler of the first embodiment will be described.

The exhaust pipe connecting structure of the muffler of the first embodiment is constructed as described above, the exhaust gas discharged from the engine flows into the first inner pipe 5 through the inlet pipe 2, thereby providing a sound attenuation effect due to expansion of the exhaust gas as the exhaust gas flows into the second sound attenuation chamber (the expansion chamber) 1b through a lot of the small holes 51b that are formed in the side wall portion of the straight pipe 51. In addition, the small-diameter end portion 51a of the straight pipe 51 opens into the first sound attenuation chamber (the resonant chamber) 1a.

Then the exhaust gas that has flown into the second sound attenuation chamber (the expansion chamber) flows into the fifth sound attenuation chamber (the expansion chamber) 1e, so that the sound attenuation effect due to the gas expansion can be obtained.

Then the exhaust gas that has flown into the fifth sound attenuation chamber (the expansion chamber) 1e flows into the fourth sound attenuation chamber (the expansion chamber) 1d through a lot of the small holes 17a that are formed in the inner plate 17, so that the sound attenuation effect due to the gas expansion can be obtained.

The exhaust gas that has flown into the fourth sound attenuation chamber (the expansion chamber) 1d is discharged to the exterior of the muffler main body 1 through the first outlet pipe 7 and the second outlet pipe 8. As the hole 7a formed in the side wall portion of the first pipe 7 communicates with the third sound attenuation chamber (the resonant chamber) 1c, the sound attenuation effect due to resonance can be obtained. In addition, a part of the exhaust gas that has flown into the third sound attenuation chamber (the expansion chamber) 1d is discharged therefrom by flowing into the second outlet pipe 8 through the small hole 8a.

As described above, in the exhaust pipe connecting structure of the muffler of the embodiment, the stay 4 is provided with the insertion hole 41 that is arranged in co-axial with the cylindrical portion 31 of the reinforcement-spacer member 3 in the hollow part of the muffler main body 1, the stay 4 having flange portions 43 formed at both of the end portions end the basal plate portion 42 thereof being fixed by welding on the inner surface of the outer shell 11. The end portion of the inlet pipe 2 is supported by the stay in the state where the end portion thereof is inserted in the insertion hole 41 of the stay 4. As a result, the inlet pipe 2 is two-point supported by the cylindrical portion 31 of the reinforcement-space member 3 and the insertion hole 41 of the stay 4, so that the stress generated due to a relative movement between the inlet pipe 2 and the outer shell 11. Therefore, the strength of the welding portions of the reinforcement-spacer member 3 and the side wall portion of the muffler main body 1 in a structure where the inlet pipe 2 penetrates the wall portion of the muffler main body 1 and it is connected with the first inner pipe 5 that is arranged in the hollow part thereof.

In addition, the diameter of the through-hole that penetrates the side wall lo portion of the outer shell 11 is formed larger than the outer diameter of the inlet pipe 2. A certain annular gap is formed between the through-hole 11a and the inlet pipe 2 so that their relative positions can be adjusted. Therefore, the inlet pipe 2 can be easily inserted in the certain position without need in a high accuracy of a position of the through hole 11a formed in the outer shell 11. This improves workability.

Further, around and along the insertion hole 41 of the stay 4, the cylindrical portion 41a is formed to project toward the hollow part of the muffler main body 1, so that it can be gas-tightly contacted with the inlet pipe 2. As a result, this can suppress generation of fluttering noise without fixation by welding.

Further, in the hollow part of the muffler main body 1, the opening portion of the L-letter shaped pipe 52, in which the end portion of the inlet pipe 2 is inserted, of the first inner pipe 5 is co-axial with the inlet pipe 2 and the insertion hole 41 of the stay 4, and the gasket 9 is provided in the opening portion of the L-letter shaped pipe 52 to seal between the L-letter shaped pipe 52 and the inlet pipe 2. Therefore, the inlet pipe can be easily inserted into the L-letter shaped pipe 52 only by inserting the inlet pipe 2 without no visibility of the interior of the outer shell 11, because the inlet pipe 2 is guided by the insertion hole 41 of the stay 4.

Further, the nice sealing can be obtained and the generation of the fluttering noise can be suppressed without the fixation by welding.

While there have been particularly shown and described with reference to preferred embodiment thereof, it will be understood that various modifications may be made therein, and it is intended to cover in the appended claims all such modifications as fall within the true spirit and scope of the invention.

For example, the exhaust pipe connecting structure of the muffler is applied to the inlet pipe side in the embodiment, while it may be applied to the outlet pipe side.

A layout in the inner space of the muffler main body 1 may be designed appropriately.

1. An exhaust pipe connecting structure of a muffler in which a through-hole is provided in one side wall portion of an outer shell of a muffler main body to penetrate a side wall portion in a state where an exhaust pipe is inserted into and supported by the through-hole, the structure being characterized in that
a diameter of the through-hole is formed larger than an outer diameter of the exhaust pipe, wherein
the exhaust pipe is fixed at a portion thereof corresponding to the through-hole with a reinforcement-spacer member that has a cylindrical portion and a flange portion, the cylindrical portion being gas-tightly connected with an outer circumferential surface of a projecting portion of the exhaust pipe and the flange portion being projected outwardly from a through-hole side edge portion of the cylindrical portion, wherein
the flange portion of the reinforcement-spacer member is fixed by welding on an outer surface of the outer shell all around the through-hole and the cylindrical portion of the reinforcement-spacer member is fixed by welding on the outer circumferential surface of the exhaust pipe all around the exhaust pipe, wherein
a stay is provided with an insertion hole that is arranged in co-axial with the cylindrical portion of the reinforcement-spacer member in a hollow part of the muffler main body, the stay having flange portions at both end thereof being fixed by welding on an inner surface of the outer shell, and wherein
an end portion of the exhaust pipe is supported by the stay in a state where the end portion is inserted in the insertion hole of the stay.

2. The exhaust pipe connecting structure of the muffler according to claim 1, wherein
the stay is formed around and along the insertion hole with a cylindrical portion that projects toward the hollow part of the muffler main body.

3. The exhaust pipe connecting structure of the muffler according to claim 1, wherein
the end portion of the exhaust pipe is inserted in and connected with an opening portion of an inner pipe that is arranged in coaxial with the exhaust pipe and the insertion hole of the stay in the hollow part of the muffler main body, and wherein
an annular sealing member is provided for sealing the opening portion of the inner pipe and the exhaust pipe that is inserted in the opening portion of the inner pipe.

4. The exhaust pipe connecting structure of the muffler according to claim 2, wherein
the end portion of the exhaust pipe is inserted in and connected with an opening portion of an inner pipe that is arranged in coaxial with the exhaust pipe and the insertion hole of the stay in the hollow part of the muffler main body, and wherein
an annular sealing member is provided for sealing the opening portion of the inner pipe and the exhaust pipe that is inserted in the opening portion of the inner pipe.
